(19) United States
(12) Patent Application Publication
(10) Pub. No.: US 2012/0287334 A1
(43) Pub. Date: Nov. 15, 2012

(54) Method of Controlling a Video-Lighting System

(75) Inventors: Lorenzo Feri, Eindhoven (NL); George Frederic Yianni, Eindhoven (NL)

(73) Assignee: KONINKLIJKE PHILIPS ELECTRONICS, N.V., Eindhoven (NL)

(21) Appl. No.: 13/522,375

(22) PCT Filed: Jan. 24, 2011
(86) PCT No.: PCT/IB2011/050293

§ 371 Date: Jul. 16, 2012

(30) Foreign Application Priority Data
Jan. 27, 2010 (EP) 10151734.0

(51) Int. Cl. H04N 5/225

(52) U.S. Cl. 348/370; 348/E05.024

(57) ABSTRACT

The invention provides a video-lighting system (100). This video-lighting system comprises a lighting system (110) comprising a plurality of lighting units with unique lighting unit identifiers. The identifiers are embedded in the light. The system further comprises a lighting unit sensor (120) configured to sense light of the plurality of lighting units and configured to detect the unique unit identifiers of the plurality of lighting units and a video device (130) configured to generate an optical image (131). The video device has an on status and an off status. The system further comprises a video sensor (132) configured to sense the status of the video device and configured to generate a corresponding video sensor signal, and a controller (150) configured to control according to a lighting plan the intensity of the light of the plurality of lighting units as a function of the video sensor signal.

### FIELD OF THE INVENTION

The invention relates to a method of controlling a video-lighting system as well as to such a video-lighting system per se. The invention also relates to a video system and to a control system that can be applied in such a method.

### BACKGROUND OF THE INVENTION

WO2008110973 describes a method of controlling the lighting of a room in accordance with a still or moving image projected onto a projection surface, which method comprises optically measuring a number of characteristic features of the projected image and adjusting the lighting of the room on the basis of the measured characteristic features. Furthermore, WO2008110973 relates to a system for controlling the lighting of a room in accordance with an image projected onto a projection surface, to a control device for use in such a system, and to a projection screen device for use in such a system. Moreover, this document describes a room lighting system for lighting a room in accordance with an image projected onto a projection surface.

WO2004006578 describes the on-line analysis of meta-data that is received together with a video signal. This analysis results in an adaptation of the lighting surrounding the presentation device. One or more characteristics of the meta-data are filtered out and translated into lighting settings of one or more light elements which in turn can contain one or more light sources.

WO2007113738 describes a method of controlling an ambient lighting element including determining ambient lighting data to control an ambient lighting element. The method includes processing combined ambient lighting data, wherein the combined ambient lighting data is based on corresponding video content portions and corresponding audio content portions. The processed combined ambient lighting data may then be used to control an ambient lighting element. In one embodiment, the combined ambient lighting data may be received as a combined ambient lighting script. Video-based ambient lighting data and audio-based ambient lighting data may be combined to produce the combined ambient lighting data. Combining the video-based and audio-based ambient lighting data may include modulating the video-based ambient lighting data by the audio-based ambient lighting data. The video content and/or audio content may be analyzed to produce the video-based and/or audio-based ambient lighting data.

### SUMMARY OF THE INVENTION

In modern office buildings every conference room is equipped with audio-video devices, like projectors and phone-conference devices. When one of these apparatus is in use, the lighting condition may need to be adapted in order to optimally fit with the current use. For example, if the projector is in the on state, it is desirable that the lighting units close to the projection screen are dimmed in intensity in order to allow for a sharper image. Nowadays, this can be achieved by manually adjusting the individual lighting units via wall dimmers. The current practice, however, is inconvenient because it involves in any case a manual operation which is boring and complicated. As a result, the user often renounces this manual procedure and accepts the poor lighting conditions. It would be desirable to fully automate this procedure.

Hence, it is an aspect of the invention to provide an alternative system, which preferably also at least partly obviates one or more of the above-described drawbacks.

In the present invention, a system and a method are disclosed that allow automatic adjusting of the lighting scene in response to the sensing of the use of an (audio-) video device. The system is based on the use of unique identifiers (e.g. network addresses) embedded in the light from every lighting unit and a device, named ‘smart controller’ (further indicated as “controller”), paired to an (audio-)video device. One or more lighting unit sensors may be installed in the vicinity of the optical image created by a given (audio-)video device. The controller detects via the one or more lighting unit sensors the unique identifiers of the lighting units (located in the surroundings of the video device). A video sensor may sense the status of the apparatus itself. Subsequently, the controller controls the identified lighting units, based on the status of the (audio-)video device. For example, if the projector is on, one or more of the lighting units may be dimmed down.

Hence, in a first aspect, the invention provides a method of controlling a video-lighting system, wherein the video-lighting system comprises:

a. a lighting system comprising a plurality of lighting units with unique lighting unit identifiers, wherein the lighting units are configured to generate light, and wherein the unique identifiers are embedded in the light;
b. a lighting unit sensor configured to sense light of the plurality of lighting units and configured to detect the unique unit identifiers embedded in the light of the plurality of lighting units;
c. a video device configured to generate an optical image, the video device having an on status and an off status;
wherein the method comprises controlling according to a lighting plan the intensity of the light of the plurality of lighting units as a function of the status of the video device, and wherein in an embodiment the lighting plan contains information based on the detection of the unique unit identifiers by the lighting unit sensor.

Such a method allows easy and automatic control of the lighting as a function of the status of the video device. For instance, such a method allows dimming of lighting units in the vicinity of the optical image of the video device and less or no dimming of lighting units more remote from the optical image.

The term “video-lighting system” relates to a system including a lighting system as well as a video device. In the context of the invention, such a video-lighting system may also comprise a lighting unit sensor and a video sensor. The video-lighting system may in general be used in a room, such as a conference room, or a space, such as a cinema, or in any other space where lighting is available and a video device is used.

Herein, the term “lighting” refers to lighting based on electrical energy, such as halogen lamps, fluorescent lamps, LED lamps, discharge lamps, etc. The term “light” especially refers to visible light, i.e. light selected from the wavelength range of 380-780 nm. The term “light” in the context of a plurality of lighting units may refer to a plurality of lights, i.e. the light of each individual lighting unit.

The lighting system comprises a plurality of lighting units. Each lighting unit may comprise one or more light sources. Hence, the lighting unit may comprise a plurality of light sources, such as in the range of 2-100 light sources. The lighting system may comprise for instance in the range of 2-500, or 4-500, or 4-50 lighting units. The number of lighting units will in general depend upon the size of the room or space. Lighting units may comprise one or more light sources selected from for instance the group of halogen lamps, fluorescent lamps, LED lamps, discharge lamps, etc.

The lighting units of the video-lighting system have unique identifiers embedded in their light. This does not exclude that also other lighting units may be available in a room or space where the video-lighting system is applied.

The unique identifier may for instance be selected from DALI (Digitally Addressable Lighting Interface), ZigBee, DMX, IP (internet protocol), and LON (local operating network), or other control protocols used for lighting systems. The unique identifier may for instance also be selected from a unique reference to a DALI (Digitally Addressable Lighting Interface), ZigBee, DMX, IP (internet protocol), or LON (local operating network) digital address, or other control protocols used for lighting systems. Such a (unique) reference may for instance refer to a library (in for instance the controller) having unique combinations of the references and the DALI, ZigBee, DMX, IP, LON, or other known digital addresses of the lighting units (and optionally other devices (from the video-lighting system)). Hence, the identifier is based on address identifiers that may be used in lighting and that can be embedded in the light. The phrase “embedded in the light” indicates that the light carries the identifier (information).

Due to the unique identifiers of the lighting units, the individual lighting units may be recognized by the lighting unit sensor (and thus the controller) and may be individually controlled by the controller.

The light of the lighting unit may not only carry identifier information, but may also embed information on lighting unit characteristics, such as one or more selected from the group (light properties) consisting of color, intensity, hue, saturation, light direction (of the light beam of the lighting unit), beam angle, lighting function, color range, intensity range (dimming properties), hue range, saturation range, light direction range, beam angle range, lighting function range, etc. The light of the lighting unit may also carry information on the location of the lighting unit. All those types of information may also be indicated as lighting unit information. The term “lighting function” refers to the possible function of lighting, such as illumination, target lighting, etc. and may include also for instance safety lighting (escape routes, escape door lighting), etc.

The phrase “are arranged to generate light” indicates that the lighting units may provide lighting (when switched on), such as illumination. The lighting of a lighting unit may have variable properties (see above). The lighting is controlled by the controller (of the video-lighting system; or other systems, see also below). The controller may include slave controllers.

The video device may for instance be a projector. The video device of the video-lighting system may for instance also be a display device. In the former case, in general an optical image is created on a screen or wall remote from the video device (such as in a cinema or such as often in conference rooms); in the latter case, the optical image is generated (displayed) on a display of the video device, for instance a TV. The term “optical image” refers to the image to be viewed by a user that uses the video device to generate images. The term “video device” may in an embodiment refer to a plurality of video devices. The term “video device” may also include an audio-video device (or audio-visual device). The term “optical image” may refer to a still or a moving image.

As mentioned above, the method comprises controlling according to a lighting plan the intensity of the light of the plurality of lighting units as a function of the status of the video device, wherein in an embodiment the lighting plan contains information based on the detection of the unique unit identifiers by the lighting unit sensor. The lighting plan is associated with the above-mentioned lighting unit sensor. For instance, during an initialization stage, the lighting unit sensor senses light of the lighting units and detects the unit identifiers to provide identity data (and preferably also intensity data) of the lighting units for the lighting plan. Therefore, the controller of the systems described herein may be configured to sense via the lighting unit sensor in an initialization stage the unique identifiers of the lighting units. Further, the controller may be configured to create, based on the unique identifier information, and optionally based on further information (provided by for instance manual input or derived from further information embedded in the light), a lighting plan for the room where the video-lighting system is available.

As indicated above, the lighting unit sensor may also be arranged to sense other properties (lighting unit information) (see also below).

Based on those data from the initialization stage, a lighting plan may be created. Based on this lighting plan the controller may, optionally based on further information, user input information and/or predefined criteria, control the lighting units as a function of the status of the video device. The lighting plan may include information on the location of the lighting units. Hence, the lighting plan may include a lighting unit map. The lighting plan may contain information based on the detection of the unique unit identifiers by the lighting unit sensor. This detection can be used to define the location of the lighting units, and thereby generate a lighting unit map. Optionally, also other properties of the light of the lighting units, such as color, intensity, etc. may be detected (see also below).

The lighting unit map (or lighting map) may contain information as to where lighting units are located in a room. This may for instance be a categorization dependent on the distance of the lighting units from the optical image when the video device generates such an image.

The lighting plan may also include a categorization of the lighting units. For instance, lighting units close to the place where the optical image is provided may be distinguished from lighting units that are more remote. This may allow dedicated lighting, wherein for instance lighting close to the optical image is dimmed more than lighting more remote from the optical image.

The lighting plan may further contain a list of (pre-defined) commands connecting status (of the video device, as sensed by the video sensor) with light intensity of the lighting units, or more especially connecting status of the video device with light intensity of categories of lighting units. Optionally, the lighting plan may further contain a list of (pre-defined) connecting status devices with one or more of the other light properties of the (respective) lighting units, such as hue, color, intensity, etc. (lighting unit information).

User input information and/or predefined criteria may for instance include one or more of the location of the optical image (when the video device is in use), the location of the optical image (when the video device is in use) in relation to the location of one or more of the lighting units, the location of the lighting units, desired intensity as a function of the status of the video device, desired color as a function of the status of the video device, desired hue as a function of the status, desired saturation as a function of the status, desired light direction as a function of the status, desired beam angle as a function of the status, etc.

In an embodiment, based on the intensity of the light, or on intensity information carried by the light, also intensities of the lighting units may be sensed by the lighting unit sensor. Hence, (also) the lighting unit sensor may be a source of information on the intensity for the lighting plan. The term “lighting unit sensor” may also refer to a plurality of lighting unit sensors.

Intensity information, either by sensing the intensity of the light or by sensing intensity information embedded in the light, may be used to provide information on the location of the lighting units. This information may be used to generate a lighting unit map.

In a preferred embodiment, the lighting unit sensor is arranged closer to the optical image (when the video device is in use and generates the optical image) than to the lighting units. In such an embodiment, the lighting unit sensor may especially be suitable to distinguish lighting units and provide a lighting unit map. In a further embodiment, when referring to a projector, the lighting unit sensor is preferably arranged within 1 m of a projection screen. In another embodiment, when referring to a display device, the lighting unit sensor is arranged within 1 m of a display of the display device. Especially, either distance may be shorter than 0.5 m.

The lighting is controlled as a function of the status of the video device. The term “status” especially refers to an “on-status”, wherein the video device generates the optical image, and to an “off-status”, wherein the video device is switched off The status may also be a stand-by status. To know the status of the video device, a video sensor may be used. Such video sensor may be integrated in the video-lighting system. In an embodiment, the video sensor may be integrated in the video device. In yet another embodiment, the video sensor may be integrated in the controller.

The video sensor may be an optical sensor, for instance sensing light from the video device (when the optical image is created), but the video device may also comprise a current sensor, configured to sense a current flow to/from/through the video device, and thereby configured to sense the status of the video device (“on”, “off”, or also “stand-by”). The term “video sensor” may in an embodiment also refer to a plurality of video sensors, for instance when a plurality of video devices is applied.

In an embodiment, a single type of optical sensor is used to sense the status of the video device as well as to sense the unique identifiers (as well as optionally other lighting unit information). Again, the term sensor may refer to a plurality of sensors.

The lighting is controlled as a function of the lighting plan. This may imply that in an embodiment, after for instance a single initialization process, the lighting unit sensor is not (further) used. Such an initialization process may be applied as an (optional) initial process when using the video-lighting system, such as when switching on the video device, or when using the video system (see below) or when using the control system (see below), respectively.

Alternatively, or additionally, the initialization process may be applied once, i.e. when installing the video-lighting system, video system or control system, respectively. Such an initialization process may include a full automatic process, including recognition of all devices within the system, especially the lighting units (based on their unique identifiers), but may optionally also include manual steps, such as input of preferences and/or input of one or more lighting unit parameters such as indicated above. The initialization process may be repeated after a change of location or parameters of devices of the video-lighting system and/or after removal or introduction of devices (including lighting units).

Hence, the lighting unit sensor may detect the identifiers of the lighting units (in the vicinity). Optionally, the lighting unit sensor also estimates their intensities and/or derives their intensities from information embedded in the light. Optionally, the lighting unit sensor may acquire more information (i.e. lighting unit information). In a specific embodiment, the lighting unit sensor is configured to sense light of the plurality of lighting units and configured to detect the unique unit identifiers embedded in the light of the plurality of lighting units, and is optionally also configured to detect further lighting unit information (properties/characteristics), such as one or more selected from the group consisting of color, intensity, hue, saturation, light direction (of the light beam of the lighting unit), beam angle, lighting function, color range, intensity range (dimming properties), hue range, saturation range, light direction range, beam angle range, lighting function range, etc., of the (respective) lighting unit(s).

This operation may be carried out during the first configuration of the system and can be triggered again manually or automatically any time the system is changed (initialization process, see also above), for example when a new lighting unit is installed. Furthermore, the lighting unit sensor may communicate the lighting unit identities and optionally intensities to the controller.

Hence, the controller may be configured to perform the initialization process when the video-lighting system (or video system or control system, respectively), is used for the first time. The controller may also be configured to perform the initialization process each time the video-lighting system (or video system or control system, respectively) is used, especially in the stage where the video device is switched on. For instance, referring to a projector, such a projector may have a warming up time, during which the initialization process may be performed. Further, the controller may be configured to perform the initialization process in regular intervals.

Hence, the controller may be configured to read out the lighting unit sensor (and derive identifier information, and optional other lighting unit information) during a first configuration of the video-lighting system. The controller may be configured to read out the lighting unit sensors when the video device is switched on, or may offer to do so. The controller may be configured to read out the lighting unit sensors when the video device is switched off (and/or in a stand-by) state. The controller may be configured to read out the lighting unit sensors when the video device is switched on at regular intervals. Further, the controller may be arranged to detect new devices, especially lighting units, with unique identifiers, and start an initialization process.

Hence, the controller may be configured to manually or automatically sense via the lighting unit sensor the unique identifiers of the lighting units, and optionally other lighting unit information, to provide identity data, optionally intensity data and optionally further lighting unit information, and update, if necessary, the lighting plan.

In this way, the lighting units are identified, and, based on their unique identifiers, the identified lighting units can be included in the lighting plan. The lighting plan may couple the lighting units, by means of their unique identifiers, to lighting intensities of the light of the lighting units as a function of the status of the video device. The intensity, and optionally also other properties of the light of the lighting units, may be coupled according to (pre-defined) commands to the status of the video device.

Hence, the lighting plan may contain information based on the detection of the unique unit identifiers by the lighting unit sensor. The lighting unit plan may thus, based on the detection by the lighting unit sensor, contain the unique identifier information associated with each lighting unit, respectively, especially selected from DALI, ZigBee, DMX, IP, and LON, or other control protocols used for lighting systems, or unique references to such DALI, ZigBee, DMX, IP, and LON, or other control protocols used for lighting systems.

The video-lighting system may be provided as a kit of parts, but the video-lighting system may also be created by using existing apparatus and providing the video system or control system according to the invention, respectively. Below, those systems are further elucidated, as far as this has not yet been done hereinabove.

Hence, in a further aspect, the invention provides a video-lighting system comprising:
a. a lighting system comprising a plurality of lighting units with unique lighting unit identifiers, wherein the lighting units are configured to generate light, and wherein the unique identifiers are embedded in the light;
b. a lighting unit sensor configured to sense light of the plurality of lighting units and configured to detect the unique unit identifiers of the plurality of lighting units;
c. a video device configured to generate an optical image, the video device having an on status and an off status;
d. a video sensor configured to sense the status of the video device and configured to generate a corresponding video sensor signal; and
e. a controller configured to control according to a lighting plan the intensity of the light of the plurality of lighting units as a function of the video sensor signal, wherein, in an embodiment, the lighting plan contains information based on the detection of the unique unit identifiers by the lighting unit sensor.

Such a system is a complete system comprising the main items, i.e. the lighting units with their specific identifiers carried by the light, the sensor to sense those identifiers, the video device and its video sensor, as well as a controller to control the lighting as a function of the status of the video device and according to a lighting plan. Such a system allows an automized response to the status of the video device, and does not need manual intervention to adjust lighting intensities.

As mentioned above, the identifier may be a DALI (Digitally Addressable Lighting Interface), ZigBee or IP identifier, or other identifier mentioned herein, or it may be a reference to such an identifier (i.e. unique reference to a control protocol used for lighting systems). In an embodiment, one or more of the lighting units comprise a plurality of light sources.

The respective devices of this video-lighting system, i.e. at least the lighting system, the video device, the video sensor, the controller and the lighting unit sensor, may be separate items, but one or more of them may also be integrated in a single unit. For instance, in an embodiment, the video sensor is integrated in the video device.

Reference is further made to the embodiments described above with respect to the method of controlling the video-lighting system, which also apply to the video-lighting system.

In yet a further aspect, the invention provides a video system, comprising:

a. a video device, selected from a group consisting of a projector and a display device, configured to generate an optical image, the video device having an on status and an off status;
b. a video sensor configured to sense the status of the video device and configured to generate a corresponding video sensor signal;
c. a controller configured to control according to a lighting plan the intensity of light of a plurality of lighting units as a function of the video sensor signal, wherein the lighting units have unique lighting unit identifiers, and wherein the lighting units are configured to generate light, wherein the unique identifiers are embedded in the light, wherein in an embodiment the lighting plan contains information based on the detection of the unique unit identifiers by the lighting unit sensor; and
d. a lighting unit sensor configured to sense light of the plurality of lighting units and configured to detect the unique unit identifiers of the plurality of lighting units.

Such a video system may be used in a room or space where a lighting system is provided, wherein the lighting units (already) have unique identifiers embedded in the lighting of those units. The controller may be used to detect all (relevant) devices for setting up the above-described video-lighting system. Then, the controller of the video system may be used to control the lighting of the lighting units in the thus created video-lighting system.

As mentioned above, the identifier may be a DALI (Digitally Addressable Lighting Interface), ZigBee or IP identifier, or other identifier mentioned herein, or it may be a reference to such an identifier.

The respective devices of this video system, i.e. at least the video device, the video sensor, the controller and the lighting unit sensor, may be separate items, but one or more of them may also be integrated in a single unit. For instance, in an embodiment, the video sensor is integrated in the video device.

Reference is further made to the embodiments described above with respect to the method of controlling the video-lighting system as well as to the embodiments described above with respect to the video-lighting system per se, which also apply to the video system. According to yet a further aspect, the invention provides a control system configured to control a video-lighting system, the control system comprising:

a. a lighting unit sensor configured to sense light of a plurality of lighting units and configured to detect the unique unit identifiers of the lighting units, wherein the lighting units are arranged to generate light, and wherein the unique identifiers are embedded in the light;
b. a video sensor configured to sense the status of a video device and configured to generate a corresponding video sensor signal, wherein the video device, selected from a group consisting of a projector and a display device, is configured to generate an optical image, the video device having an on status and an off status;
c. a controller configured to control according to a lighting plan the intensity of light of the plurality of lighting units as a function of the video sensor signal, wherein in an embodiment the lighting plan contains information based on the detection of the unique unit identifiers by the lighting unit sensor.

Such a control system may be used in a room or space where a lighting system is provided, wherein the lighting units (already) have unique identifiers embedded in the lighting of those units and wherein a (conventional) video device is available or can be provided. The controller may be used to detect all (relevant) devices for setting up the above-described video-lighting system. Then, the controller of the video system may be used to control the lighting of the lighting units in the thus created video-lighting system. As mentioned above, the identifier may be a DALI (Digitally Addressable Lighting Interface), ZigBee or IP identifier, or other identifier mentioned herein, or may be a reference to such an identifier.

Reference is further made to the embodiments described above with respect to the method of controlling the video-lighting system as well as to the embodiments described above with respect to the video-lighting system per se, which also apply to the control system.

The respective devices of this control system, i.e. at least the video sensor, the controller and the lighting unit sensor, may be separate items, but one or more of them may also be integrated in a single unit. For instance, the video sensor may be integrated in the controller. Further, in an embodiment, the lighting unit sensor may be integrated in the controller. This is further elucidated in the table below:

| | Video-lighting | | |
|---|---|---|---|
| | system | Video system | Control system |
| Lighting | included | Not included | Not included |
| system | | but addressed | but addressed |
| | | by controller | by controller |
| Video device | included | included | Not included |
| | | | but sensed by |
| | | | video sensor |
| Lighting unit | included | included | included |
| sensor | | | |
| Video sensor | included | included | included |
| Controller | included | included | included |

In the header, the three described systems of the invention are indicated; in the rows below the header, it is indicated whether the lighting system, lighting unit sensor, video device, video sensor, and controller are included in the system. As mentioned above, the term “system” may refer to a kit of parts, and does not necessarily refer to a single device.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1b schematically depict embodiments of the video-lighting system;

FIGS. 2a-2c schematically depict several systems of the invention; and

FIGS. 3a-3b schematically depict some specific embodiments of a method of controlling the video-lighting system.

### DESCRIPTION OF PREFERRED EMBODIMENTS

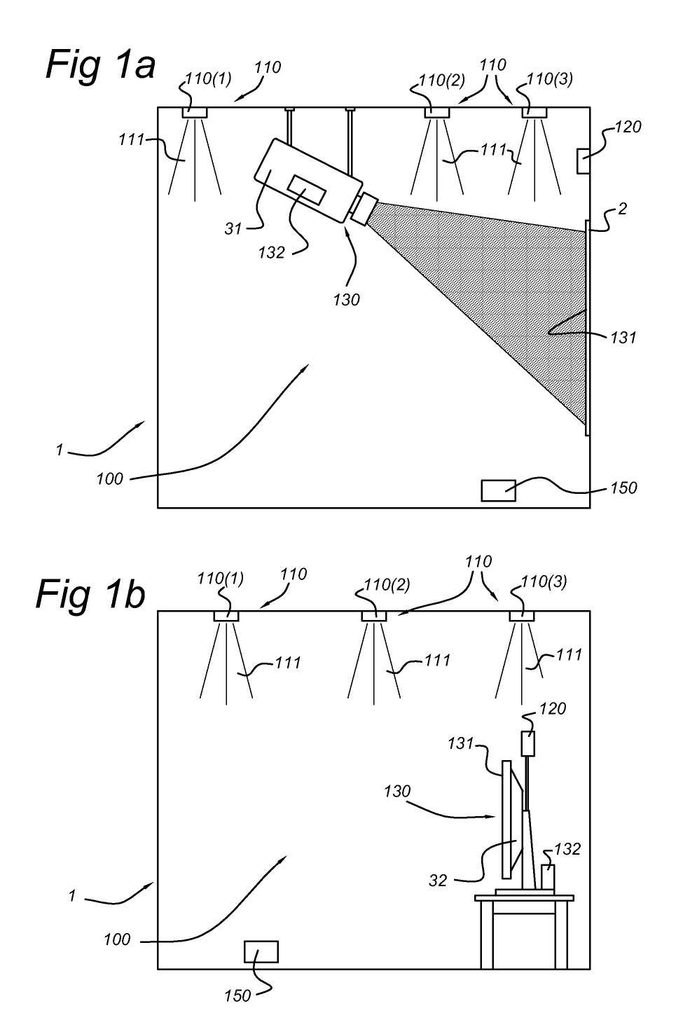

FIG. 1a schematically depicts a room or space 1, further indicated as room 1, accommodating a video-lighting system 100 according to the invention. The video-lighting system 100 may include a video system or a control system (see below), but for the sake of understanding, here the “complete video-lighting system 100” is discussed.

The video-lighting system 100 comprises a lighting system 110, comprising lighting units 110(1), 110(2), 110(3). Herein, the phrase “110(1) . . . ” indicates a plurality of lighting units. The lighting units 110(1) . . . are arranged to generate light. Light is indicated with reference 111. Though light of the lighting units 110(1) . . . is indicated with a single reference 111, herein, the lighting units may be arranged to provide different types of visible light. Hence, one or more of the plurality of lighting units may differ in lighting unit properties. For instance, one or more lighting units may be arranged to provide warm white light and one or more lighting units may be arranged to provide cool white light, etc.

The video-lighting system 100 further comprises a video device 130, which is in this embodiment a projector 31. The video device 130 is in this embodiment arranged to generate an optical image 131 at a distance of the video device 130. Here, by way of example, the optical image 131 is displayed at a screen 2, attached to a wall. The optical image 131 may for instance be an image (projected slide) of a presentation; it may be an image of a movie, etc. The video-lighting system 100 further comprises a video sensor 132, which is arranged to detect the status of the video device 130, such as an on-status, an off-status, or optionally also a stand-by status. The video sensor 132 may be attached to the video device 130, such as shown by way of example in this Figure, but may also be integrated in the video device 130.

The video-lighting system 100 further comprises a lighting unit sensor 120. This lighting unit sensor 120 is arranged to detect the identifiers of the lighting units 110(1) . . . . In fact, the lighting units 110(1) . . . are sensed by sensing the identifiers of the light 111 of the respective lighting units 110(1) . . . .

Further, the video-lighting system 100 comprises a controller 150. The controller 150 receives sensor signals from the lighting unit sensor(s) 120 and from the video sensor 132. Based on a lighting plan, the controller 150 controls the (respective) lighting units 110(1) . . . .

FIG. 1b schematically depicts a similar embodiment of the video-lighting system 100 as schematically depicted in FIG. 1a, with this difference that the video-lighting system 100 is not a projector 31 as in FIG. 1a, but a display device 32.

The video sensor 132 and the lighting unit sensor 120 are shown as separate devices, but one or more of them may also be integrated in another device, such as the video device 130 or the controller 150. Especially, the video sensor 132 may be integrated in the video device 130. The lighting unit sensor 120 may be integrated in the display device 32. As will be clear to the person skilled in the art, the lighting unit sensor 120 is an optical sensor, whereas the video sensor may be an optical sensor but may also be for instance a current sensor (see also above).

In a specific embodiment, not depicted in the accompanying drawings, the video sensor 132 and the lighting unit sensor 120 are a single sensor, or a plurality of a single type of sensors (optical sensors).

The devices, such as the controller 150 with the lighting unit sensor 120, the video sensor 132 and the lighting system 110 (lighting units 110(1) . . . ) may communicate wirelessly or wired.

By way of example, the lighting plan, which may include a set of (pre-defined) commands linking intensity of the light of the lighting units 110(1) . . . and status of the video device 130, may schematically look as follows:

| | | Position | | Intensity of | Intensity of |
|---|---|---|---|---|---|
| | Unique | (i.e. distance to | Intensity | lighting unit | lighting unit |
| Lighting | identifier | sensor 120) | range of | with status video | with status video |
| unit | (address) | (“map”) | lighting unit | device on | device off |
| Lighting | IP1 | 110(1) > 110(2) | 0-100 | 80 | 100 (i.e. “on”) |
| unit | | 110(1) > 110(3) | | | |
| 110(1) | | 110(2) > 110(3) | | | |
| Lighting | IP2 | 110(2) < 110(1) | 0-100 | 50 | 100 |
| unit | | 110(2) > 110(3) | | | |
| 110(2) | | 110(1) > 110(3) | | | |
| Lighting | IP3 | 110(3) < 110(1) | 0-100 | 20 | 100 |
| unit | | 110(3) < 110(2) | | | |
| 110(3) | | 110(2) < 110(1) | | | |

The lighting unit properties: identifier, position and intensity range are here included in the plan. The identifier has been sensed by the lighting unit sensor and one or more of the position and intensity range may be detected by lighting unit sensor(s). Alternatively or additionally, information about one or more of the position and intensity range may be derived from information embedded in the light of the lighting units, and may also be sensed by the lighting unit sensor(s). The identifiers are by way of example indicated with references IP1, IP2 . . . . The unique identifiers may also be selected from types of identifiers other than IP addresses, or may be selected from unique references to such protocols used for lighting systems.

The items “intensity of lighting unit with status video device on” and “intensity of lighting unit with status video device off” are commands that may be pre-defined, either manually during a (first) initialization, or as commands already integrated in a computer program product with executable instructions, which when run on a computer, performs the method of the invention. Those items may directly be linked to the respective lighting units, or may indirectly be linked to those lighting units, but may be directly linked to a categorization (such as shown in the third column, with the categorization based on distance).

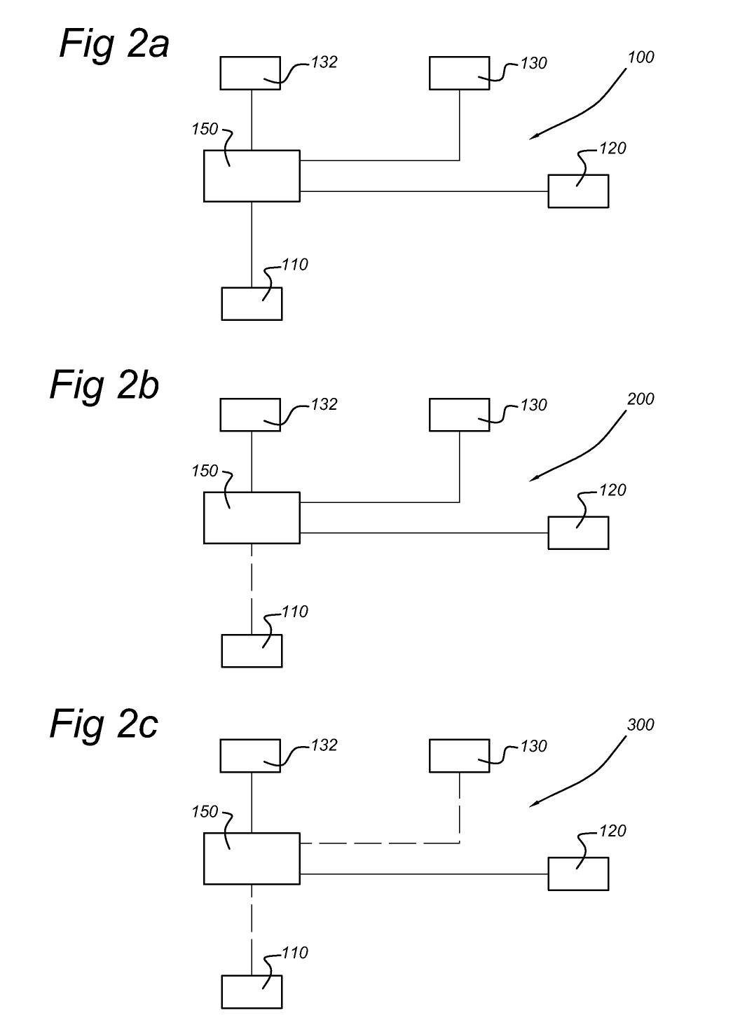

FIG. 2a schematically depicts an embodiment of the video-lighting system 100. The specific devices that in general belong to the video-lighting system 100 are indicated, i.e. the video device 130, the video sensor 132, the lighting system 110, the lighting unit sensor 120, and the controller 150. FIG. 2b schematically depicts an embodiment of the video system 200. The specific devices that in general belong to the video system 200 are indicated, i.e. the video device 130, the video sensor 132, the lighting unit sensor 120, and the controller 150. The video system 200 may communicate with the lighting system 110 via controller 150. FIG. 2c schematically depicts an embodiment of the control system 300. The specific devices that in general belong to the control system 300 are indicated, i.e. the video sensor 132, the lighting unit sensor 120, and the controller 150. The video system 200 may communicate with the lighting system 110 and the video device 130 via controller 150.

In FIGS. 1a and 1b, respective integral video-lighting systems 100 are schematically depicted. However, such an integral video-lighting system 100 may be composed of the video system 200 and the lighting system 110, or may be composed of the control system 300 and the video device 130 and the lighting system 110. For the sake of clarity, the different embodiments are indicated in the table below:

| | Types of video-lighting systems and their structure | | |
|---|---|---|---|
| Lighting system | All included in | Not included | Not included |
| 110 | the video-lighting | but addressed | but addressed |
| | system 100 | by controller | by controller |
| Video device | | Video system | Not included |
| 130 | | 200 | but sensed by |
| | | | video sensor |
| Lighting unit | | | Control system |
| sensor 120 | | | 300 |
| Video sensor | | | |
| 132 | | | |
| Controller 150 | | | |

A computer program product, which, when run on a computer, can perform the method of the invention, as well as a data carrier carrying such computer program product, are also part of this invention.

Therefore, a video-lighting system is proposed comprising lighting units that are able to embed unique identifiers in their light outputs, a controller, to sense the signal of the lighting unit sensor, to detect the unique identifiers of the lighting units (in the vicinity), and a detector, named ‘video sensor’, to sense the status of an video device. As mentioned above, the term “video device” may also relate to an audio-video device. The controller controls (the status) of the lighting units. The controller has access to the lighting units via wired or wireless means.

The sensor(s) (video sensor and/or lighting unit sensor) and the controller can be integrated inside a single casing or can be separate. In the latter case, the units can communicate with each other via wired or wireless means.

The invention further provides a method of controlling the video-lighting system. The lighting unit sensor (installed in the vicinity of the video device to which it may be connected) detects the identifiers of the lighting units (in the vicinity). Possibly, the controller may via the lighting unit sensor also derive information about the relative positions of the various lighting units, for example by measuring the intensity or deriving intensity information from information embedded in the light. The controller may also derive other properties from the light and/or information embedded in the light. The video sensor senses the status of the given video device. The controller controls the lighting units with respect to the status of the video device, such as a display video device, and according to prescribed rules.

In an example, such as shown in FIG. 1a, the goal may be to dim the lighting units denoted as lighting units 110(3) to 20% of the total light output, and the lighting units denoted as lighting units 110(2) to 30% when the video device 130, here projector 31, is switched on.

To achieve this goal, according to an embodiment of the invention, a video-lighting system comprising the following elements is used: a lighting system 110 comprising lighting units 110(1) . . . that are able to embed unique identifiers in their light outputs and a controller system 300. The video sensor 132 of the controller system 300 senses the status of a video device. The controller 150 of the controller system controls the status of the lighting units, or more in general, controls the intensity of the light according to a lighting plan. The controller has access to the lighting units via wired or wireless means. The devices of the control system 300 may be separated and may be installed in different locations. Devices may communicate with each other via wireless communication links.

In an embodiment, the lighting unit sensor 120 may comprise a photo-detector and a processor to run detection algorithms. The lighting unit sensor 120 may be installed next to the screen. In that position, it can detect the identities of the lighting units in the vicinity and may optionally also estimate their relative intensities.

The video sensor may, in an embodiment, be installed next to the projector or other video device. It can detect the on-off status of the projector or other video device for example by measuring the electrical power utilized. The video sensor may also be able to detect the stand-by status of the projector or other video device.

The controller 150 can be installed in any position of the room 1. It can receive information from the lighting unit sensor 120 and from the video sensor 132. In the preferred embodiment, the following method may be used:

The lighting unit sensor 120 detects the identifiers of the lighting units 110(1) . . . (in the vicinity) and estimates their intensities or receives information on their intensities. This operation is performed during the first configuration of the video-lighting system 100 and can be triggered again manually or automatically any time the video-lighting system 100 is changed, for example when a new lighting unit 110(n) is installed. Furthermore, the lighting unit sensor 120 may communicate the identities and intensities of the lighting units to the controller 150.

The video sensor 132 senses the on status, or off status (or stand-by status) of the video device 130, such as a projector. Then it communicates the status to the controller 150.

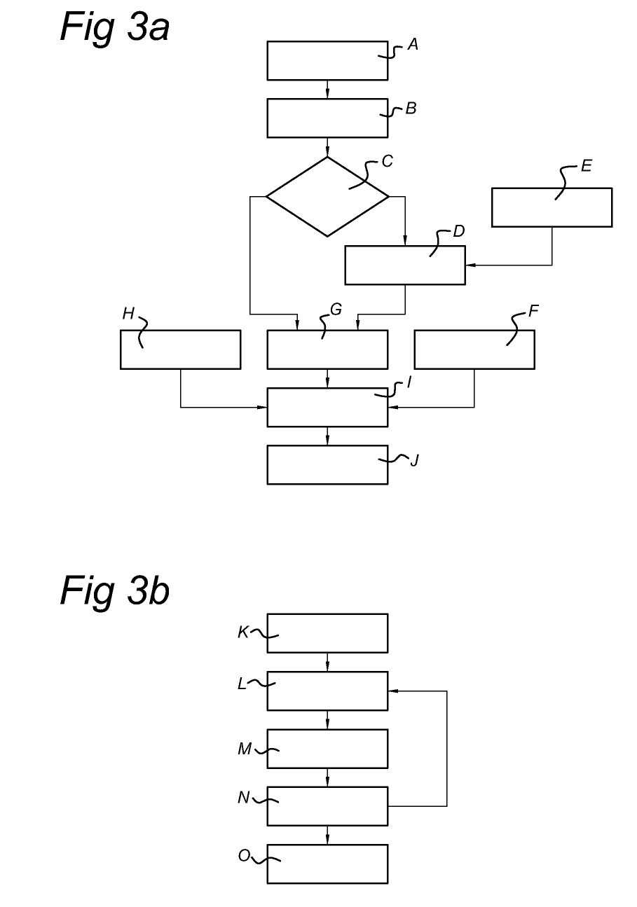

The controller 150 receives the list of lighting unit identities and intensities and sorts them based on the intensities. The top lighting unit is the one with the highest estimated intensity and hence the most relevant. Furthermore, when the lighting plan (indicating the position of lighting units in the room) is available, the controller combines the information about the lighting unit list with the lighting plan to derive lighting unit groups, for example group 110(3), group 110(2), group 110(1) in FIG. 1a. In the end, the controller obtains a (grouped) list of lighting units sorted by the estimated intensity. This list is stored in memory. This operation may be performed during the first configuration of the video-lighting system 100 and can be triggered again manually or automatically any time the video-lighting system is changed, for example when a new lighting unit is installed. During normal operation, the controller 150 may receive video device status updates from the video sensor 132. This information is processed together with the lighting unit list described above. Based on built-in or manually configured control rules, the controller derives the desired light output for each lighting unit. FIG. 3a shows a flow diagram of the procedure that may be followed by the controller 150 in an embodiment.

The controller communicates the desired light output to the various lighting units 110(1) . . . .

Referring to FIG. 3a, reference A refers to the input of lighting unit intensities and identities. Stage B refers to an optional sorting of the lighting units, based on their intensities. Stage C checks whether a lighting unit map is available. If so, lighting unit groups may be defined, reference D. Input from a lighting map, reference E, may also be obtained. If no lighting map is available, stage G indicates the stage where a (grouped) list of lighting units sorted by (estimated) intensities is made available. This can for instance be done by detecting both intensities and identities. Stage I indicates the stage where the control rules are applied to the lighting units, based on ranking and status of the video device. This stage I may receive input from control rules, reference H, and a sensing signal, reference F, from the sensor for sensing the video device. Reference J indicates the control commands for each lighting unit, indicating for instance the desired intensity, and optional other properties, such as color, hue, direction, etc.

In an alternative embodiment of this invention (particularly applicable to projectors or other display devices) the following method is used:

The lighting unit sensor examines the light effect of the lighting units in a certain area (typically the area the video device, such as a projector, illuminates).

Each lighting unit can generate, at a required time or constantly, light in which its video-lighting system address (to be used by the controller) is embedded. In this way the lighting unit sensor can extract the contribution of each lighting unit to the light effect in the observed area.

The video sensor can sense the status of the video device by its power consumption, but also, in the case of a projector, by examining the light effect in the area the projector illuminates.

When the video sensor detects that the video device is in the on-state, the video-lighting system reads the contribution of each lighting unit to the light effect on the wall. It then reduces the brightness of each detected lighting unit via the controller (using a feedback loop) until the contribution on the wall reaches the required threshold for comfortable viewing.

Referring to FIG. 3b, reference K indicates the stage that the video sensor senses the on-status of the video device. Reference L indicates that the lighting unit sensor detects the contribution of each lighting unit to a light effect in a certain area (for instance the display/screen of a display device (see FIG. 1b) or the projection area where an optical image is projected when a projector is applied (see FIG. 1a). Reference M indicates that the controller reduces the intensity of one or more lighting units. Reference N indicates the stage where the controller controls whether the contribution of the (respective) lighting units in the area is as required (for instance below a certain threshold). If no, the method returns to L, until the required contribution is achieved. If yes, the stage of the desired light is achieved, indicated with reference O.

The term “substantially” herein, such as in “substantially all emission” or in “substantially consists”, will be understood by the person skilled in the art. The term “substantially” may also include embodiments with “entirely”, “completely”, “all”, etc. Hence, in embodiments the adjective “substantially” may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”.

The present invention may also be embodied as a computer program product, e.g. in the form of a software code stored on a medium such as an optical disk (CD, DVD, BD), a semiconductor memory unit (USB stick, SD-card, etc), which comprises executable instructions. The executable instructions enable a processor (e.g. a general purpose computer provided with interface circuitry) to carry out the method embodiments as described above.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in sequences other than those described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method of controlling a video-lighting system comprising a lighting system comprising a plurality of lighting units with unique lighting unit identifiers, wherein the lighting units are configured to generate light, and wherein the lighting unit identifiers are embedded in the light; a lighting unit sensor configured to sense light of the plurality of lighting units and configured to detect the unique unit identifiers embedded in the light of the plurality of lighting units; and a video device configured to generate an optical image, the video device having an on status and an off status, the method comprising controlling according to a lighting plan the intensity of the light of the plurality of lighting units as a function of the status of the video device, wherein the lighting plan contains information based on the detection of the unique unit identifiers by the lighting unit sensor.

2. The method according to claim 1, comprising an initialization process wherein the lighting unit sensor senses light of the lighting units and detects the lighting unit identifiers to provide identity data and optionally intensity data of the lighting units for the lighting plan.

3. The method according to claim 1, wherein the video device is a projector or a display device.

4. The method according to claim 1, wherein the identifier is a DALI (Digitally Addressable Lighting Interface), ZigBee or IP identifier, or a unique reference to such an identifier.

5. A video-lighting system comprising:
a lighting system comprising a plurality of lighting units with unique lighting unit identifiers, wherein the lighting units are configured to generate light, and wherein the lighting unit identifiers are embedded in the light;
a lighting unit sensor configured to sense light of the plurality of lighting units and configured to detect the unique lighting unit identifiers of the plurality of lighting units;
a video device configured to generate an optical image, the video device having an on status and an off status;
a video sensor configured to sense the status of the video device and configured to generate a corresponding video sensor signal; and
a controller configured to control according to a lighting plan the intensity of the light of the plurality of lighting units as a function of the video sensor signal, wherein the lighting plan contains information based on the detection of the unique unit identifiers by the lighting unit sensor.

6. The video-lighting system according to claim 5, wherein the video device is a projector or a display device.

7. The video-lighting system according to claim 5, wherein the identifier is a DALI (Digitally Addressable Lighting Interface), ZigBee or IP identifier, or a unique reference to such an identifier.

8. The video-lighting system according to claim 5, wherein the controller is configured to manually or automatically sense via the lighting unit sensor the unique identifiers of the lighting units, to provide identity data, and update, if necessary, the lighting plan.

9. A video system, comprising:
a video device, selected from a group consisting of a projector and a display device, configured to generate an optical image, the video device having an on status and an off status;
a video sensor configured to sense the status of the video device and configured to generate a corresponding video sensor signal;
a controller configured to control according to a lighting plan the intensity of light of a plurality of lighting units as a function of the video sensor signal, wherein the lighting units have unique lighting unit identifiers, wherein the lighting units are configured to generate light, wherein the lighting unit identifiers are embedded in the light, wherein the lighting plan contains information based on the detection of the unique unit identifiers by a lighting unit sensor; and
the lighting unit sensor configured to sense light of the plurality of lighting units and configured to detect the unique unit identifiers of the plurality of lighting units.

10. The video system according to claim 9, wherein the video sensor is integrated in the video device.

11. The video system according to claim 9, wherein the identifier is a DALI (Digitally Addressable Lighting Interface), ZigBee or IP identifier, or a unique reference to such an identifier.

12. A control system, configured to control a video-lighting system, the control system comprising:
a lighting unit sensor configured to sense light of a plurality of lighting units and configured to detect unique unit identifiers of the lighting units, wherein the lighting units are configured to generate light, and wherein the lighting unit identifiers are embedded in the light;
a video sensor configured to sense the status of a video device and configured to generate a corresponding video sensor signal, wherein the video device, selected from a group consisting of a projector and a display device, is configured to generate an optical image, the video device having an on status and an off status; and
a controller configured to control according to a lighting plan the intensity of light of the plurality of lighting units as a function of the video sensor signal, wherein the lighting plan contains information based on the detection of the unique unit identifiers by the lighting unit sensor.

13. The control system according to claim 12, wherein the video sensor is integrated in the controller.

14. The control system according to claim 12, wherein the lighting unit sensor is integrated in the controller.

15. The control system according to claim 12, wherein the identifier is a DALI (Digitally Addressable Lighting Interface), ZigBee or IP identifier, or a unique reference to such an identifier.
